(19) United States
(12) Patent Application Publication
(10) Pub. No.: US 2024/0318831 A1
(43) Pub. Date: Sep. 26, 2024

(54) UNDER-INDUCTION SYSTEM HAVING FUNCTION OF REGENERATING AIR

(71) Applicant: PEACEWORLD CO., LTD, Gyeonggi-do (KR)

(72) Inventors: Myung Ock LEE, Gyeonggi-do (KR); Sang Woo KIM, Gyeonggi-do (KR)

(21) Appl. No.: 18/383,483

(22) Filed: Oct. 25, 2023

(30) Foreign Application Priority Data
Mar. 21, 2023 (KR) 10-2023-0036775

(51) Int. Cl. F24C 15/20; H05B 6/12

(52) U.S. Cl. CPC F24C 15/2042; F24C 15/2035; H05B 6/12

(57) ABSTRACT

The present invention relates to an induction system and, more specifically, to an under-induction system having a function of regenerating air. The under-induction system according to an embodiment of the present invention includes an air regeneration unit separating and removing foreign matter contained in a gas introduced into the air regeneration unit and discharging regenerated air to an outside of the air regeneration unit.

### CROSS-REFERENCE TO RELATED APPLICATION

The present application claims priority to Korean Patent Application No. 10-2023-0036775, filed Mar. 21, 2023, the entire contents of which are incorporated herein by reference.

### BACKGROUND

### Technical Field

The present invention relates to an induction system and, more specifically, to an under-induction system having a function of regenerating air. The under-induction system may purify smoke generated in a process of cooking food and discharge the purified, clean air to an indoor space.

### Background Art

Heating devices for cooking food, such as a microwave oven, a gas stove, an oven, and the like, have been used. Recently, an induction range has been increasingly used to address issues, such as indoor air pollution, increase in room temperature, etc. As a cooking appliance that adopts a heating method of electromagnetic induction, the induction range is advantageous in many aspects, such as in high energy efficiency and stability. Also, the induction range provides benefits in that the induction range rarely consumes oxygen and does not emit waste gas. In such an induction range, lines of magnetic force produced when a high-frequency current is applied pass through a bottom of an induction cooking container laid on a top plate of the induction range, at which point an eddy current generated by a resistance component only heats the induction cooking container.

When the induction range is used to cook food, water vapor, oil vapor, smoke, and the like are generated from the food as the food is heated up. An amount of smoke generated during cooking increases particularly when the food is fish or meats. Also, the water vapor and the oil vapor splashes or drops to surroundings, producing oil residues.

A duct system is installed with the induction range to discharge indoor air to an outside, which may limit installation of the induction range in high-class indoor environments, such as hotels. Even when the duct system is present, problems in hygiene, cleanliness, and aesthetic deterioration may be unavoidable if the duct system is not properly managed.

### SUMMARY

Embodiments of the present invention have been made in an effort to solve the above-mentioned problems. An objective of the present invention is to provide an under-induction system that can provide clean, purified air to an indoor space by including a means for regenerating air inside a table where an induction range is installed.

An objective of the present invention is to provide a comfortable indoor space by minimizing smoke, smell, and the like generated in a process of cooking food using an induction range. It is an objective of the present invention to effectively remove an oil included in oil vapor especially when fish, meats, and the like are cooked. Additionally, it is an object of the present invention to provide an under-induction system that is easy to maintain.

Through the above, it is an objective of the present invention to provide an under-induction system that can be used in a high-class setting, such as hotels.

According to an embodiment, an under-induction system having a function of regenerating air comprises a table to which a top plate for transmitting a magnetic field is coupled, an induction unit fixedly installed at a lower side of the top plate and heating a designated container positioned at an upper side of the top plate, a hood portion drawing in a gas generated when food is heated in the designated container, the hood portion being installed in the table, a connection portion having a first end communicating with the hood portion and providing a moving path for the gas drawn in, an oil separation portion disposed inside the connection portion and filtering an oil contained in the gas, and an air regeneration unit communicating with a second end of the connection portion, wherein, after separating and removing foreign matter contained in the gas introduced from a first side of the air regeneration unit, the air regeneration unit discharges regenerated air to a second side of the air regeneration unit.

In an embodiment, the oil separation portion may be disposed inside the connection portion to communicate with the hood portion, wherein a cross-sectional area of the oil separation portion may be tapered from a top of the oil separation portion to a bottom of the oil separation portion.

In an embodiment, the oil separation portion may include an upper separation portion having a plurality of inclination holes and a direction change portion provided in a lower side of the upper separation portion and reflecting the gas moving in a downstream direction.

In an embodiment, the plurality of inclination holes may have a predetermined angle of elevation from ground.

In an embodiment, the air regeneration unit may include a chamber portion, a motor portion moving the gas within the chamber portion, and a cell portion for electrical separation, disposed within the chamber portion and collecting oil particles and dust contained in the gas by an electrostatic action.

In an embodiment, the cell portion may include a grid filter portion disposed on a face of the cell portion and made of a mesh net formed of a metal material, the grid filter portion filtering the oil particles and the dust having a viscosity, an ionization portion configured such that the oil particles and the dust contained in the gas introduced through the grid filter portion have a first polarity, and an adsorption filter portion, wherein a plurality of spacer plates having a second polarity is disposed in the adsorption filter portion to adsorb the oil particles and the dust having the first polarity.

In an embodiment, the air regeneration unit may further include a multi-filter portion disposed at a side of the chamber portion and including a plurality of different filter layers.

According to the above-described features of the present invention, various effects including the following may be expected. However, the present invention can function without providing all the effects described below.

According to the present invention, a comfortable indoor space can be provided by minimizing smoke, smell, and the like generated in a process of cooking food using an induction range. According to the present invention, an oil included in oil vapor may be effectively removed especially when fish, meats, and the like are cooked. In addition, according to the present invention, an under-induction system that is easy to maintain can be provided.

Through the above, an under-induction system that can be used in a high-class setting, such as hotels, may be provided.

### BRIEF DESCRIPTION OF THE DRAWINGS

FIG. 1 is a schematic view of an under-induction system according to an embodiment of the present invention.

FIG. 2 shows regeneration of a gas generated when food is heated in a designated container through the under-induction system of FIG. 1.

FIG. 3 shows separation of oil by an oil separating portion according to an embodiment.

FIG. 4 shows separation of oil by an oil separation portion according to another embodiment.

FIG. 5 shows a cell portion 630 for electrical separation, separated from an air regeneration unit 600.

FIG. 6 depicts the cell portion 630.

FIG. 7 shows a hood portion 310 according to another embodiment.

### DETAILED DESCRIPTION

Example embodiments of the present disclosure are described with reference to the appended drawings to enable a sufficient understanding about elements and effects of the present disclosure. However, the present disclosure is not limited to the disclosed embodiments below. Various forms may be obtained, and various modifications can be applied. Below, in describing the present invention, explanation on related known functions may be omitted if it is determined that the known functions are well-known to one having ordinary skill in the art and may obscure essence of the present invention.

Terms, such as “first,” “second,” etc., may be used herein to describe various elements. However, the elements should not be understood as being limited by these terms. These terms may be only used in distinguishing one element from another. For example, a first element may be referred to as a second element, and, similarly, a second element may be referred to as a first element, within the scope of the present disclosure.

Herein, terms, such as “comprise,” “include,” “have,” etc., are designed to indicate features, numbers, steps, operations, elements, components, or a combination thereof are present. It should be understood that presence of one or more other features, numbers, steps, operations, elements, components, or a combination thereof or a possibility of addition thereof are not excluded.

Terms used herein are only to explain certain embodiments but not to limit the present invention. A singular representation may include a plural representation unless a clearly different meaning can be grasped from the context. Unless defined differently, terms used in embodiments of the present disclosure may be interpreted as generally known terms to one having ordinary skill in the art.

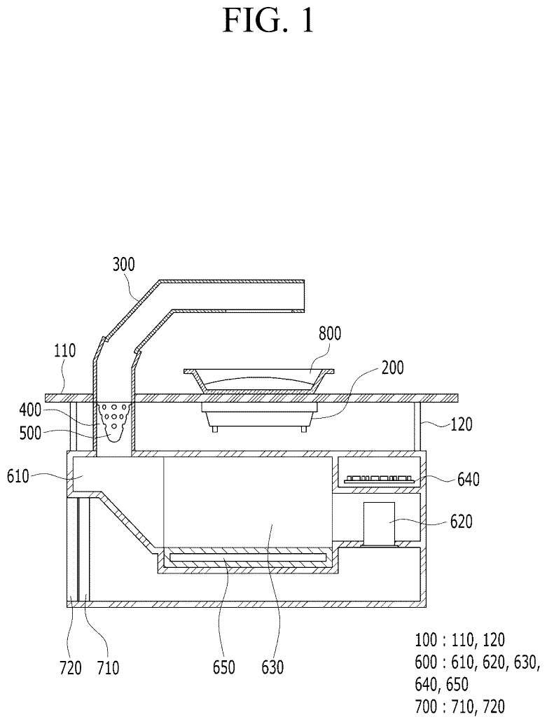

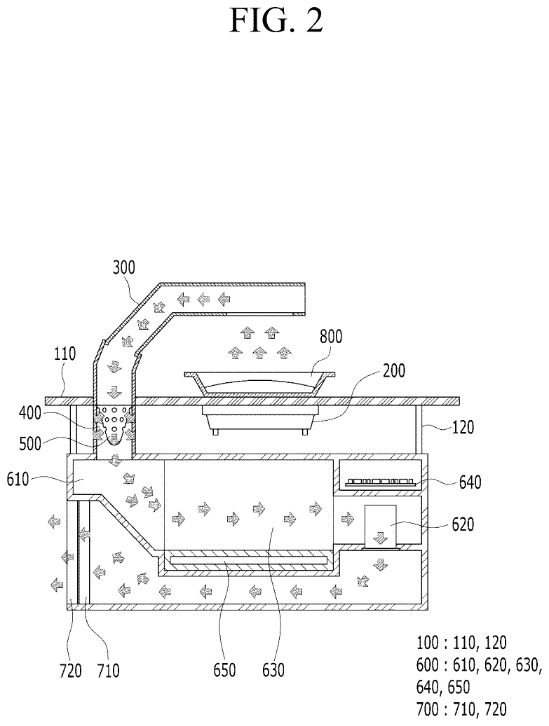

Example embodiments of the present invention are described in detail with reference to the appended drawings. FIG. 1 is a schematic view of an under-induction system according to an embodiment of the present invention, and FIG. 2 shows regeneration of a gas generated when food is heated in a designated container 800 through the under-induction system of FIG. 1.

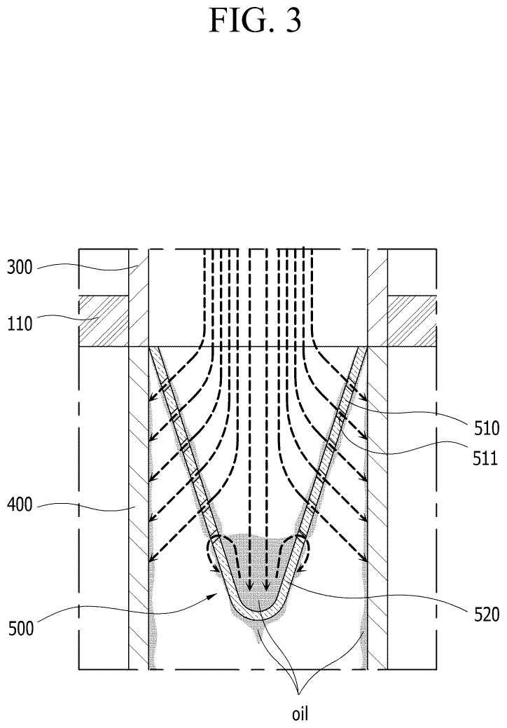

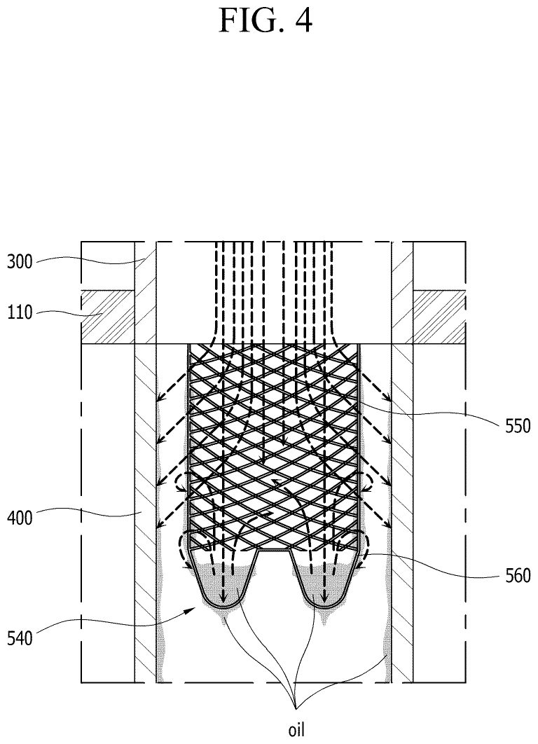

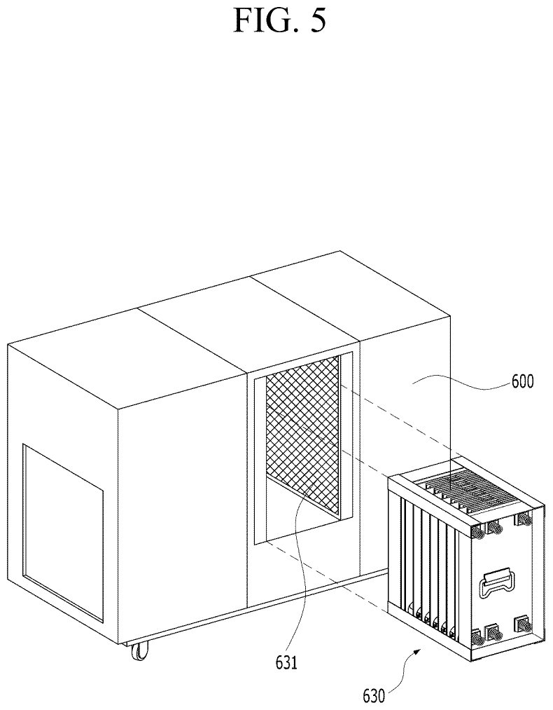

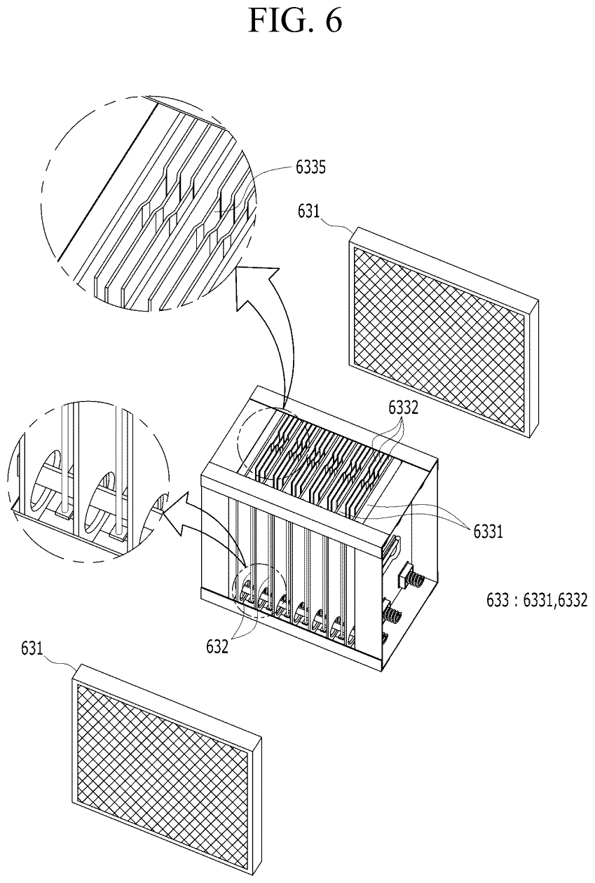

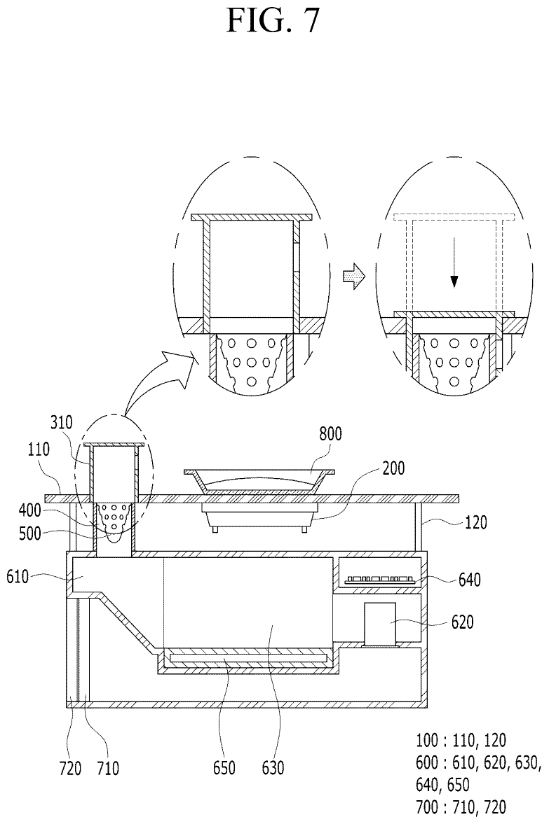

FIG. 3 shows separation of an oil by an oil separation portion 500 according to an embodiment, and FIG. 4 shows separation of an oil by an oil separation portion 540 according to another embodiment. FIG. 5 shows a cell portion for electrical separation 630, separated from an air regeneration unit 600, and FIG. 6 depicts the cell portion 630. FIG. 7 shows a hood portion 310 according to another embodiment.

Referring to FIGS. 1 through 7, an under-induction system according to an embodiment of the present invention comprises a table 100, an induction unit 200, the hood portion 300, a connection portion 400, the oil separation portion 500, the air regeneration unit 600, a multi-filter portion 700, and the like. In addition, the system may further comprise the designated container 800 having good energy efficiency. The designated container 800 may be a container designed to be used in an induction heating system.

The table 100 may include a top plate 110, a frame 120, and the like. The top plate 110 is coupled to an upper portion of the frame 120. The top plate 110 is positioned at a predetermined height from the ground. The top plate 110 is an element where the induction unit 200 is installed. The top plate 110 may be a top plate of a general table or the like.

In particular, the top plate 110 is capable of transmitting a magnetic field and is coupled to the table 100 according to an embodiment. To this end, the top plate 110 may be formed of any one of materials selected from a group of non-magnetic materials, such as marble, wood, glass, and the like. Moreover, a top surface and a bottom surface of the top plate 110 may be flat. In an embodiment, the top plate 110 may have a thickness in a predetermined range. The thickness of the top plate 110 may be varied depending on the material of the top plate 110.

In an embodiment, a sticker may be attached to or a pattern may be engraved on the top surface of the top plate 110 to indicate a center location of the designated container 800. The center location of the designated container 800 may be changed based on a position of the induction unit 200. This allows a user to visually identify an optimal location for positioning the designated container 800.

The induction unit 200 heats food within the designated container 800 in an indirect manner by inducing heat in the designated container 800 using the magnetic field. While heating the food, smoke may be generated depending on a type of food. Particularly, an amount of smoke may even increase when food with much oil, such as fish and meats, is cooked.

The induction unit 200 according to an embodiment is fixedly installed under the top plate 110 and heats the designated container 800 positioned above the top plate 110. The induction unit 200 induces the magnetic field generated by a circular coil therein to the designated container 800 positioned above the top plate 110.

The circular coil is disposed in an inner space defined in the induction unit 200. It is necessary for the circular coil according to an embodiment to maximize heating efficiency with respect to the designated container 800 by increasing the number of turns per unit area. To this end, the circular coil may be wound coaxially in a circular coil base portion (not shown) by a plurality of turns. The circular coil may include at least one or more layers.

A controller 640 generates a control signal that controls the induction unit 200. The controller 640 may be prepared using an electrical wire arranged in a printed circuit board and circuit elements, such as a semiconductor, a condenser, and a resistor, disposed on a top thereof. The controller 640 may control the induction unit 200 according to a series of cooking method (under certain time and temperature settings) predetermined according to the type of food. For instance, the controller 640 may turn off power to the induction unit 200 when cooking is completed. The controller may control the induction unit 200 to be automatically stopped after a predetermined time, e.g., 5 minutes. In an embodiment, a remote controller may be installed in the top plate 110. The controller 640 may generate the control signal by the remote controller.

The hood portion 300 is installed in the table 100. The hood portion 300 draws in a gas generated when the food is heated in the designated container 800. The gas may include water vapor, oil vapor, foreign substances, and the like. The foreign substances may include oil particles, dust, and the like.

The hood portion 300 according to an embodiment is formed by bending a tube having a predetermined length. A first end of the hood portion 300 is disposed above the designated container 800, and a second end thereof is coupled to the top plate 110. The hood portion 300 draws in the gas generated from the designated container 800, minimizing the gas from spreading to surroundings of the table 100. According to another embodiment, the first end of the hood portion 300 may be diverged into at least two, each of which is disposed above at least two or more designated container 800. According to still another embodiment, the hood portion 300 may be formed by being coupled to at least one or more short tubes.

According to an embodiment, a gas intake hole is formed at an upper portion of a side of the hood portion 310, and the rest of sides of the hood portion 310 are closed to form a plate. The hood portion 310 may be moved up or down by operation of a lifting means. A lifted height of the hood portion 310 may be adjusted. An inner passage is formed in the hood portion 310 to discharge a gas drawn through the gas intake hole to the connection portion 400 or the oil separation portion 500.

An end of the connection portion 400 communicates with the hood portion 300. The connection portion 400 provides a moving path for the drawn gas. In an embodiment, the connection portion 400 may be shaped as a pipe. Specifically, an upper portion of the connection portion 400 communicates with the hood portion 300. The connection portion 400 extends vertically downward from a lower side of the top plate 110 of the table 100. As a result, the gas introduced into the connection portion 400 through the hood portion 300 may move in a downstream direction. In addition, the other end of the connection portion 400 may communicate with the air regeneration unit 600.

The oil separation portion 500 is disposed in the connection portion 400. The oil separation portion 500 may function as filtering the oil contained in the gas, so the oil contained in the gas may be primarily filtered. The oil separation portion 500 according to an embodiment may be disposed inside the connection portion 400 or in an upper portion of an inner side of the connection portion 400. Also, it is preferable that a cross sectional area of the oil separation portion 500 may be gradually decreased from the top to the bottom thereof. In other words, the oil separation portion 500 according to an embodiment may be shaped as a cone where an upper portion is generally open.

The oil separated while the oil passes through the oil separation portion 500 may be formed in the oil separation portion 500. The oil may be formed at each of an inner side and outer side of the oil separation portion 500. The oil (or an oil layer) formed in the outer side of the oil separation portion 500 may flow along the outer side of the oil separation portion 500 by gravity, so oil drops may be formed at a lower side of the oil separation portion 500. The oil drops may vertically fall by gravity. The gas passing through the oil separation portion 500 may form the oil (or the oil layer) on an inner circumference of the connection portion 400. Then the oil may flow down along the inner circumference of the connection portion 400 by gravity.

To be illustrated, the oil separation portion 500 may include an upper separation portion 510 and a direction change portion 520. The upper separation portion 510 may filter a part of the oil contained in the gas. To this end, the upper separation portion 510 may include a plurality of inclination holes 511. The plurality of the inclination holes may be preferably formed to have a predetermined angle of elevation from ground.

The gas introduced through an upper opening of the oil separation portion 500 may be discharged to the outer side of the oil separation portion 500 through the plurality of the inclination holes 511. The discharged gas may collide with the inner circumference of the connection portion 400 at an angle, which causes the oil (or the oil layer) to be gradually formed in the inner circumference of the connection portion 400.

Each of the plurality of the inclination holes 511 according to the present invention may include a protrusion. The protrusion may adsorb part of the oil contained in the gas passing through the inclination holes 511.

The direction change portion 520 is formed below the upper separation portion 510 and reflects the gas moving in the downstream direction. When the gas moving in the downstream direction contacts and collides with the direction change portion 520, the direction of the gas may be diverted into different directions including an upstream direction. A part of the diverted gas may be discharged to the outer side of the oil separation portion 500 through the inclination holes 511.

During this process, the oil contained in the gas may be gradually formed in the inner and outer sides of the oil separation portion 500 and the inner circumference of the connection portion 400. Then the oil flows downward by gravity. The direction change portion 560 may accommodate the oil flowing along the inner side of the oil separation portion 500.

According to another embodiment, the oil separation portion 540 may be disposed in an upper side of the inner side of the connection portion 400 to communicate with the hood portion 300. Particularly, the oil separation portion 540 may include an upper separation portion 550 and a direction change portion 560. The upper separation portion 550 may be shaped as a cylinder having a hollow therein and may be a metal net formed by weaving wires made of a metal material. The gas may be discharged to the outer side of the oil separation portion 540 through vent holes formed between the wires.

The direction change portion 560 is formed below the upper separation portion 550. The direction change portion 560 may include a ring-shaped groove to change the direction of the gas moving in the downstream direction when the gas is reflected. As a result, the part of the oil that has changed its direction may be discharged to the outer side of the oil separation portion 540 through the vent holes.

During this process, the oil contained in the gas may be gradually formed in the inner and outer sides of the oil separation portion 540 and the inner circumference of the connection portion 400. Then the oil flows downward by gravity. The direction change portion 560 may accommodate the oil flowing down along the inner side of the oil separation portion 540.

According to an embodiment of the present invention, the air regeneration unit 600 may communicate with the other end of the connection portion 400. The air regeneration unit 600 may separate and remove foreign substances included in the gas introduced from a side thereof and discharge regenerated gas to the other side thereof.

Specifically, the air regeneration unit 600 according to an embodiment of the present invention may include a chamber portion 610, a motor portion 620, a cell portion 630 for electrical separation, a controller 640, an oil storage portion 650, the multi-filter portion 700, and the like.

The chamber portion 610 may provide a receiving space therein. The receiving space may include a space where the gas introduced through the connection portion 500 may temporarily stay. In an embodiment, the chamber portion 610 may be divided by a partition wall to separate a space for regenerating a gas, a space where the controller 640 is disposed, a space for the motor portion 620 is disposed, and the like, for instance. The chamber portion 610 may be disposed below the table 100. In an embodiment, an inlet is formed at an upper portion of a first side of the chamber portion 610, and an outlet is formed at a second side of the chamber portion 610. The inlet communicates with the lower side of the connection portion 400.

The first side at the inlet side of the chamber portion 610 may have an inclination plane having a preset angle of elevation. This allows the oil filtered from the oil separation portion 500 and dropped to move to the oil storage portion 650 along the inclination portion as described below. In an embodiment, the first side at the inlet side of the chamber portion 610 may have a plurality of inclination planes, some of which have a different angle of elevation.

Also, a driving portion, such as a wheel for rolling may be formed in the lower portion of the chamber portion 610, thereby helping a user easily move the induction system.

The motor portion 620 may move the gas inside the chamber portion 610. The motor portion 620 operates such that the gas is drawn into the chamber portion 610 and the gas is discharged to the outer side of the chamber portion 610 to form a flow of the gas. To this end, the motor portion 620 may include a fan. When the fan is operated, the gas within the chamber portion 610 may flow more freely. The motor portion 620 may be an electric motor driven by electric energy.

In an embodiment, the motor portion 620 may be disposed at a rear side of the cell portion 630. The motor portion 620 allows the gas discharged through the cell portion 630 to convert its direction from a horizontal direction to a vertical downward direction. As a result, the motor portion 620 may enable the gas to flow from the cell portion 630 toward the multi-filter portion 700. In addition, the motor portion 620 may enable the gas to be discharged to the outer side of the chamber portion after the gas passes through the multi-filter portion 700.

The cell portion 630 is disposed inside the chamber portion 610. The cell portion 630 collects oil particles and dust contained in the gas by an electrostatic action. Referring to FIG. 5, in an embodiment, the cell portion 630 may include a grid filter portion 631, an ionization portion 632, an adsorption filter portion 633, and the like. In an embodiment, the cell portion 630 may be detachable from the chamber portion 610 for maintenance. To this end, the chamber portion 610 may be provided with a door that is closable or openable.

In an embodiment, the cell portion 630 may have a shape of a rectangular prism having an inner space. The gas may be introduced through a front face of the cell portion 630 and discharged through a rear face thereof. In an embodiment, the ionization portion 632 is disposed at a side where the gas is introduced in the cell portion 630. The adsorption filter portion 633 may be disposed along a direction along which the gas flows in and out.

In an embodiment, the grid filter portion 631 may be disposed at the front face of the cell portion 630. In an embodiment, two grid filter portions 631 may be opposingly disposed at each of the front face and the rear face of the cell portion 630. The grid filter portion 631 may be formed of a mesh net made of a metal material to filter the oil particles and dust having a viscosity. The grid filter portion 631 may be made by overlapping the mesh nets tightly woven by wires. Filter materials may be also disposed between the mesh net.

The grid filter portion 631 may provide a function of physical filtering. Specifically, the gas passing through the grid filter portion 631 collides with the mesh net. The oil particles and dust having a viscosity may be separated from the gas and attached to the mesh net. When the gas continues to pass through the grid filter portion 631, a volume such as of the oil particles and dust attached to the mesh net increases. Consequently, the oil particles and dust having a viscosity fall by gravity when the volume thereof exceeds a preset volume, which may move to the oil storage portion 650.

In an embodiment, the ionization portion 632 may allow the oil particles and dust contained in the gas introduced through the grid filter portion 631 to have a first polarity. A plurality of wires made of metal are disposed at a certain distance apart in the ionization portion 632. The plurality of the wires may be disposed in a vertical direction. As a high voltage current is applied to the plurality of the wires, electrical discharge occurs at around the wires. In other words, a strong electric field may be formed around the wires. When the gas through the grid filter portion 631 passes through a space where the gas is electrically discharged, the oil particles and dust in the gas may have the first polarity. The first polarity may be negative or positive.

A plurality of spacer plates having a second polarity are disposed to face each other in the adsorption filter portion 633. The adsorption filter portion 633 adsorbs the oil particles and dust having the first polarity. The plurality of the spacer plates are positioned to face each other such that the gas moves through an empty space between the spacer plates. As the spacer plates have the second polarity, the oil particles and dust having the first polarity in the passing gas may be adsorbed by electrical attraction. Here, it is preferable that the first polarity and the second polarity have a different polarity.

In an embodiment, the spacer plates divide the inner space of the cell portion 630, which forms a plurality of flow channels for the gas to improve efficiency in adsorption of the oil particles and dust. In an embodiment, the spacer plates include first spacer plates 6331 partitioning the inner space of the cell portion 630 and second spacer plates 6332 disposed in the space partitioned by the first spacer plates 6331. It is preferable that the second spacer plates 6332 are adjacent and spaced apart with each other.

In an embodiment, the ionization portion 632 may be disposed in a portion where the gas is introduced, i.e., in an inlet side of the first spacer plates 6331. In an embodiment, the wire of the ionization portion 632 is arranged vertically at the inlet of the first spacer plates 6331.

In addition, in an embodiment, a protrusion groove portion 6335 bent to any one side to protrude may be formed in a middle of each second spacer plate 6332. The protrusion groove portion 6335 extends vertically. The protrusion groove portions 6335 in the second spacer plates 6332 may face with each other. Accordingly, efficiency of adsorption of the oil particles and the dust may be enhanced. Also, an area of the second spacer plate 6332 is preferably smaller than an area of the first spacer plate 6331.

The adsorption filter portion 633 may primarily adsorb the oil particles and the dust in the gas through the first spacer plates 6331. Subsequently, the adsorption filter portion 633 secondarily may adsorb the oil particles and the dust in the gas using the second spacer plates 6332. To this end, the second spacer plates 6332 may be biased to the rear side of the cell portion 630.

Moreover, the spacer plates may be disposed to have continuously alternating negative polarity and positive polarity. The oil particles and the dust having the first polarity are adsorbed by electrical attraction in the spacer plates having the second polarity. On the other hand, the spacer plates having the first polarity may push the oil particles and the dust having a same polarity therewith toward the spacer plates having the second polarity.

The multi-filter portion 700 may be disposed at a side of the chamber portion. Specifically, the multi-filter portion 700 may be preferably disposed in the outlet of the chamber portion. The multi-filter portion 700 may include a plurality of different filter layers. The multi-filter portion 700 according to an embodiment may be a double-layer filter having a first filter 710 and a second filter 720. The first filter may be a bag filter, and the second filter may be a carbon filter. In an embodiment, the bag filter is a filter having a shape of a sack or a pouch and may be formed of glass fiber, cotton, synthetic fiber, and the like. The carbon filter is a filter using active carbons, such as anthracite or bituminous coal, and may remove stench and smell contained in the gas.

In an embodiment, a channel through which the gas moves in a direction parallel to the ground may be formed between the motor portion and the multi-filter portion. The gas passing through the motor portion may move toward the multi-filter portion by power of the motor portion. In this process, the oil particles and dust remaining in the gas may fall to a bottom face of the channel by gravity. The multi-filter portion 700 may finally filter the gas passing through the channel and discharge the purified gas to the outside of the chamber portion.

In an embodiment, the oil storage portion 650 may be disposed at a vertically lower side of the cell portion 630. The oil storage portion 650 stores the oil particles and the dust fallen from the cell portion 630. At a side of the oil storage portion 640, a valve may be arranged. The oil stored in the oil storage portion 650 may be discharged by the valve.

The controller 640 may generate a control signal controlling the motor portion 620, the cell portion 630, and the like. The controller 640 may control a rotation speed of the fan in the motor portion 620 to adjust a suction force for the gas introduced into the air regeneration unit 600, a moving speed of the gas moving inside the air regeneration unit 600, and the like. In addition, the controller 640 may adjust a voltage applied to the cell portion 630 and the like. Also, the controller may automatically cease supplying a current for safety when the aforementioned door is opened to detach the cell portion 630.

Preferred embodiments of the present invention are explained as an example above, but the scope of the present invention is not limited to those described embodiments. Modifications can be made within the scope of the claims.

What is claimed is:

1. An under-induction system having a function of regenerating air, comprising:
a table to which a top plate for transmitting a magnetic field is coupled;
an induction unit fixedly installed at a lower side of the top plate and heating a designated container positioned at an upper side of the top plate;
a hood portion drawing in a gas generated when food is heated in the designated container, the hood portion being installed in the table;
a connection portion having a first end communicating with the hood portion and providing a moving path for the gas drawn in;
an oil separation portion disposed inside the connection portion and filtering an oil contained in the gas; and
an air regeneration unit communicating with a second end of the connection portion, wherein, after separating and removing foreign matter contained in the gas introduced from a first side of the air regeneration unit, the air regeneration unit discharges regenerated air to a second side of the air regeneration unit.

2. The under-induction system of claim 1, wherein the oil separation portion is disposed inside the connection portion to communicate with the hood portion, wherein a cross-sectional area of the oil separation portion is tapered from a top of the oil separation portion to a bottom of the oil separation portion.

3. The under-induction system of claim 2, wherein the oil separation portion includes:
an upper separation portion having a plurality of inclination holes; and
a direction change portion provided in a lower side of the upper separation portion and reflecting the gas moving in a downstream direction.

4. The under-induction system of claim 3, wherein the plurality of inclination holes has a predetermined angle of elevation from ground.

5. The under-induction system of claim 1, wherein the air regeneration unit includes:
a chamber portion;
a motor portion moving the gas within the chamber portion; and
a cell portion for electrical separation, disposed within the chamber portion and collecting oil particles and dust contained in the gas by an electrostatic action.

6. The under-induction system of claim 5, wherein the cell portion includes:
a grid filter portion disposed on a face of the cell portion and made of a mesh net formed of a metal material, the grid filter portion filtering the oil particles and the dust having a viscosity;
an ionization portion configured such that the oil particles and the dust contained in the gas introduced through the grid filter portion have a first polarity; and
an adsorption filter portion, wherein a plurality of spacer plates having a second polarity is disposed in the adsorption filter portion to adsorb the oil particles and the dust having the first polarity.

7. The under-induction system of claim 5, wherein the air regeneration unit further includes a multi-filter portion disposed at a side of the chamber portion and including a plurality of different filter layers.
